(19) United States
(12) Patent Application Publication
(10) Pub. No.: US 2021/0142364 A1
(43) Pub. Date: May 13, 2021

(54) METHOD AND SYSTEM FOR REAL-TIME TRACKING AND ATTRIBUTION OF ADVERTISEMENTS FOR UNSTRUCTURED SUPPLEMENTARY SERVICE DATA BANKING

(71) Applicant: Terragon Holdings Mauritius, Ebene (MU)

(72) Inventors: Elochukwu UMEH, Lagos (NG); Ayodeji BALOGUN, Lagos (NG); Amit KHEMCHANDANI, Bengaluru (IN); Mohit RAWAT, Bengaluru (IN)

(73) Assignee: Terragon Holdings Mauritius, Ebene (MU)

(21) Appl. No.: 16/680,386

(22) Filed: Nov. 11, 2019

(51) Int. Cl. G06Q 30/02

(52) U.S. Cl. CPC G06Q 30/0269; G06Q 30/0267; G06Q 30/0255; G06Q 30/0273; G06Q 30/0244; G06Q 30/0246; G06Q 30/0261; G06Q 30/0277

(57) ABSTRACT

The present disclosure provides a computer-implemented method and system for real-time tracking and attribution of advertisements for a plurality of subscriber transactions. The computer-implemented method and system corresponds to a tracking and marketing system. The tracking and marketing system integrates one or more telecommunication network channels, a plurality of banking partners, and a plurality of application servers. The tracking and marketing system receives a first set of data. The tracking and marketing system obtains a second set of data. The tracking and marketing system fetches a third set of data. The tracking and marketing system analyzes the first set of data, the second set of data, and the third set of data. The tracking and marketing system identifies a match. The tracking and marketing system tracks the subscriber. The tracking and marketing system initiates one or more marketing campaigns. The tracking and marketing system displays one or more advertisements.

### TECHNICAL FIELD

The present invention relates to the field of financial advertising and, in particular, relates to real-time tracking and attribution of advertisements for unstructured supplementary service data banking.

### BACKGROUND

Over the past few years, targeted marketing is the fastest growing advertising medium in the field of telecommunication industry for various banking solutions. Improvements in the telecommunication technologies have led to an increase in the number of banking transactions provided by the various banking partners using communication partner with the feature communication device. In addition, few of the banking transactions are facilitated through the unstructured supplementary service data. Typically, a user initiates the transaction through the feature communication device using the text message to the banking partner. Further, banking partners offer numerous products which might include banking services, load offers, transaction discounts, and banking offers following the banking transactions made by the user. The telecommunication industry has created rigorous competition between the banking partners. In addition, the banking partners must aggregate or develop comprehensive advertisement offers that matches the interests and the needs of users. The banking partners run basic business practices for targeted marketing through analysis of customer behavior and communication with users through a variety of channels. However, the present systems and methods do not allow tracking of the banking transactions made by the users. In addition, the present systems and methods do not allow identification of the specific customer or user for displaying the advertisements. In addition, the present systems and methods do not allow creation of different groups for the users to run various marketing campaigns based on their interests and needs.

In the light of the above stated discussion, there is a need for system that overcomes the above stated disadvantages.

### SUMMARY

In a first example, a computer-implemented method is provided. The computer-implemented method is configured to perform real-time tracking and attribution of advertisements for unstructured supplementary service data banking. The unstructured supplementary service data banking includes USSD financial transactions or mobile transactions across verticals such as betting, investment, insurance, payments and transfers. The computer implemented method corresponds to a tracking and marketing system with a processor. The computer-implemented method includes a first step to enable integration of one or more telecommunication network channels, a plurality of banking partners, a plurality of application servers and a plurality of subscribers. In addition, the computer-implemented method includes a second step to receive a first set of data associated with the plurality of subscribers. Further, the computer-implemented method includes a third step to obtain a second set of data associated with the plurality of subscribers. Furthermore, the computer-implemented method includes a fourth step to fetch a third set of data associated with the plurality of subscribers. Moreover, the computer-implemented method includes a fifth step to analyze the first set of data, the second set of data, and the third set of data based on one or more machine learning algorithms. Also, the computer-implemented method includes a sixth step to identify a match of the subscriber of the plurality of subscribers and corresponding plurality of subscriber transactions for initialization of one or more marketing campaigns. The computer-implemented method includes a seventh step to enable tracking of the subscriber of the plurality of subscribers associated with corresponding one or more communication devices based on the corresponding plurality of subscriber transactions. The computer-implemented method includes an eighth step to create the one or more marketing campaigns for the identified subscriber of the plurality of subscribers associated with the corresponding plurality of subscriber transactions. The computer-implemented method includes a ninth step to trigger initialization of the one or more marketing campaigns on the one or more communication devices based on a pre-defined criterion. The computer-implemented method includes a tenth step to display one or more advertisements associated with the one or more marketing campaigns based on identified subscriber of the plurality of subscribers. The one or more telecommunication network channels, the plurality of banking partners, the plurality of application servers and the plurality of subscribers are integrated in real-time through a communication network. The plurality of subscribers is associated with the one or more communication devices. The first set of data is received with facilitation of the one or more telecommunication network channels and the plurality of banking partners in real-time. The plurality of subscribers is associated with the one or more of communication devices. The second set of data is received with facilitation of the plurality of banking partners in real-time. The third set of data is fetched from the plurality of application servers based on activities of the plurality of subscribers in real-time through the one or more communication devices. The analysis is performed based on training of a machine learning model, wherein analysis is performed based on one or more patterns to identify and track a subscriber of the plurality of subscriber and the corresponding plurality of subscriber transactions. The analysis of the first set of data, the second set of data, and the third set of data is done in real-time. The match of the subscriber and the corresponding plurality of subscriber transactions is identified in real-time. The subscriber is tracked based on the corresponding plurality of subscriber transactions in real-time. The one or more marketing campaigns are created in real-time. The pre-defined criterion is associated with the plurality of banking partners and the one or more telecommunication network channels based on the identified subscriber of the plurality of subscribers. The one or more marketing campaigns are triggered in the real-time. The one or more advertisements are displayed on the one or more communication devices. The one or more advertisements are displayed on the one or more communication devices in real-time. The tracking and marketing system with the processor provides tracking attribute for unstructured supplementary service data banking, payment and purchase transactions. The tracking and marketing system with the processor facilitates attribution of the one or more marketing campaigns for the plurality of banking partners.

In an embodiment of the present disclosure, the tracking and marketing system connects with the one or more telecommunication network channels through the communication network. The first set of data corresponds to a subscriber data. The subscriber data is received through the one or more telecommunication network channels. The subscriber data includes name data, age data, gender, locations data, contact number data, email address data, communication device information, and call behavior analytics. In addition, the subscriber data includes subscriber communication state, subscriber relationship status, subscriber active services, network address, and date of birth.

In an embodiment of the present disclosure, the second set of data corresponds to a subscriber transaction data. The subscriber transaction data includes banking partner name, banking partner code, transaction amount, transaction identity, transaction date, transaction time, transaction requests, types of transaction, and item purchased. The communication network provides a medium for the plurality of subscribers to connect with the tracking and marketing system through the one or more communication devices.

In an embodiment of the present disclosure, the third set of data corresponds to the activities of the plurality of subscribers based on the plurality of applications servers through the one or more communication devices. The third set of data includes subscriber surfing data, subscriber applications data, subscriber demographic data, subscriber technology interests, subscriber language data, application preference data, and subscriber clicks data.

In an embodiment of the present disclosure, the computer-implemented method may create the machine learning model to perform analysis of the first set of data, the second set of data, and the third set of data. In addition, the machine learning model is trained based on the one or more patterns to identify and track the subscriber of the plurality of subscribers from the analyzed first set of data, second set of data, and third set of data.

In an embodiment of the present disclosure, the computer-implemented method may generate a plurality of groups associated with the plurality of subscribers based on the analyzed first set of data, second set of data, and third set of data. The plurality of subscriber transactions includes subscriber transactions for purchase, subscriber transactions for loan, subscriber transactions for mortgage, and subscriber transactions for banking. The plurality of groups is guided to the plurality of banking partners and the one or more telecommunication network channels through the communication network. Each of the plurality of groups is generated and sent in real-time.

In an embodiment of the present disclosure, the computer-implemented method may receive a set of rules. The set of rules is received from a server based on one or more inputs of an administrator. The one or more inputs include optimal time for marketing campaign, optimal marketing model, optimal banking balance, optimal season for marketing, and optimal tariff mark. The set of rules can be modified by the administrator in real-time.

In an embodiment of the present disclosure, the computer-implemented method may customize the one or more marketing campaigns for the identified subscriber of the plurality of subscribers associated with the corresponding plurality of subscriber. The one or more marketing campaigns are customized in real-time.

In an embodiment of the present disclosure, each of the plurality of subscriber is identified and tracked based on analysis done by the machine learning model for initiating the one or more marketing campaigns. The one or more marketing campaigns include advertisement goals of the plurality of banking partners and the one or more telecommunication network channels. In addition, the advertisement goals are targets wished to achieve by the plurality of banking partners and the one or more telecommunication network channels. Each of the plurality of subscriber is identified and tracked for the one or more marketing campaigns in real-time.

In an embodiment of the present disclosure, the identified and tracked subscriber of the plurality of subscribers associated with the corresponding one or more communication devices receives the one or more advertisements. The one or more advertisements are displayed on the plurality of communication devices based on the analysis of the first set of data, the second set of data, and the third set of data. In addition, the plurality of banking partners, the one or more telecommunication network channels and the administrator are alerted based on the pre-defined criterion for initiation of the one or more marketing campaigns. The pre-defined criterion includes end of transaction session, end of online banking session, end of offline banking session, end of short message service, end of voice call, and end of short message service data.

In a second example, a computer system is provided. The computer system includes one or more processors, a signal generator circuitry embedded inside a computing device for generating a signal, and a memory. The memory is coupled to the one or more processors. The memory stores instructions. The instructions are executed by the one or more processors. The execution of the instructions causes the one or more processors to perform a method for real-time tracking and attribution of advertisements for unstructured supplementary service data banking. The unstructured supplementary service data banking includes USSD financial transactions or mobile transactions across verticals such as betting, investment, insurance, payments and transfers. The method corresponds to a tracking and marketing system. The method includes a first step to enable integration of one or more telecommunication network channels, a plurality of banking partners, a plurality of application servers and a plurality of subscribers. In addition, the method includes a second step to receive a first set of data associated with the plurality of subscribers. Further, the method includes a third step to obtain a second set of data associated with the plurality of subscribers. Furthermore, the method includes a fourth step to fetch a third set of data associated with the plurality of subscribers. Moreover, the method includes a fifth step to analyze the first set of data, the second set of data, and the third set of data based on one or more machine learning algorithms. Also, the method includes a sixth step to identify a match of the subscriber of the plurality of subscribers and corresponding plurality of subscriber transactions for initialization of one or more marketing campaigns. The method includes a seventh step to enable tracking of the subscriber of the plurality of subscribers associated with corresponding one or more communication devices based on the corresponding plurality of subscriber transactions. The method includes an eighth step to create the one or more marketing campaigns for the identified subscriber of the plurality of subscribers associated with the corresponding plurality of subscriber transactions. The method includes a ninth step to trigger initialization of the one or more marketing campaigns on one or more communication devices based on a pre-defined criterion. The method includes a tenth step to display one or more advertisements associated with the one or more marketing campaigns based on identified subscriber of the plurality of subscribers. The one or more telecommunication network channels, the plurality of banking partners, the plurality of application servers and the plurality of subscribers are integrated in real-time through a communication network. The plurality of subscribers is associated with the one or more communication devices. The first set of data is received with facilitation of the one or more telecommunication network channels and the plurality of banking partners in real-time. The plurality of subscribers is associated with the one or more of communication devices. The second set of data is received with facilitation of the plurality of banking partners in real-time. The third set of data is fetched from the plurality of application servers based on activities of the plurality of subscribers in real-time through the one or more communication devices. The analysis is performed based on training of a machine learning model, wherein analysis is performed based on one or more patterns to identify and track a subscriber of the plurality of subscriber and the corresponding plurality of subscriber transactions. The analysis of the first set of data, the second set of data, and the third set of data is done in real-time. The match of the subscriber and the corresponding plurality of subscriber transactions is identified in real-time. The subscriber is tracked based on the corresponding plurality of subscriber transactions in real-time. The one or more marketing campaigns are created in real-time. The pre-defined criterion is associated with the plurality of banking partners and the one or more telecommunication network channels based on the identified subscriber of the plurality of subscribers. The one or more marketing campaigns are triggered in the real-time. The one or more advertisements are displayed on the one or more communication devices. The one or more advertisements are displayed on the one or more communication devices in real-time. The tracking and marketing system provides tracking attribute for unstructured supplementary service data banking, payment and purchase transactions. The tracking and marketing system facilitates attribution of the one or more marketing campaigns for the plurality of banking partners.

In a third example, a non-transitory computer-readable storage medium is provided. The non-transitory computer-readable storage medium encodes computer executable instructions that, when executed by at least one processor, performs a method for real-time tracking and attribution of advertisements for unstructured supplementary service data banking. The unstructured supplementary service data banking includes USSD financial transactions or mobile transactions across verticals such as betting, investment, insurance, payments and transfers. The method corresponds to a tracking and marketing system. The method includes a first step to enable integration of one or more telecommunication network channels, a plurality of banking partners, a plurality of application servers and a plurality of subscribers. In addition, the method includes a second step to receive a first set of data associated with the plurality of subscribers. Further, the method includes a third step to obtain a second set of data associated with the plurality of subscribers. Furthermore, the method includes a fourth step to fetch a third set of data associated with the plurality of subscribers. Moreover, the method includes a fifth step to analyze the first set of data, the second set of data, and the third set of data based on one or more machine learning algorithms. Also, the method includes a sixth step to identify a match of the subscriber of the plurality of subscribers and corresponding plurality of subscriber transactions for initialization of one or more marketing campaigns. The method includes a seventh step to enable tracking of the subscriber of the plurality of subscribers associated with corresponding one or more communication devices based on the corresponding plurality of subscriber transactions. The method includes an eighth step to create the one or more marketing campaigns for the identified subscriber of the plurality of subscribers associated with the corresponding plurality of subscriber transactions. The method includes a ninth step to trigger initialization of the one or more marketing campaigns on one or more communication devices based on a pre-defined criterion. The method includes a tenth step to display one or more advertisements associated with the one or more marketing campaigns based on identified subscriber of the plurality of subscribers. The one or more telecommunication network channels, the plurality of banking partners, the plurality of application servers and the plurality of subscribers are integrated in real-time through a communication network. The plurality of subscribers is associated with the one or more communication devices. The first set of data is received with facilitation of the one or more telecommunication network channels and the plurality of banking partners in real-time. The plurality of subscribers is associated with the one or more of communication devices. The second set of data is received with facilitation of the plurality of banking partners in real-time. The third set of data is fetched from the plurality of application servers based on activities of the plurality of subscribers in real-time through the one or more communication devices. The analysis is performed based on training of a machine learning model, wherein analysis is performed based on one or more patterns to identify and track a subscriber of the plurality of subscriber and the corresponding plurality of subscriber transactions. The analysis of the first set of data, the second set of data, and the third set of data is done in real-time. The match of the subscriber and the corresponding plurality of subscriber transactions is identified in real-time. The subscriber is tracked based on the corresponding plurality of subscriber transactions in real-time. The one or more marketing campaigns are created in real-time. The pre-defined criterion is associated with the plurality of banking partners and the one or more telecommunication network channels based on the identified subscriber of the plurality of subscribers. The one or more marketing campaigns are triggered in the real-time. The one or more advertisements are displayed on the one or more communication devices. The one or more advertisements are displayed on the one or more communication devices in real-time. The tracking and marketing system provides tracking attribute for unstructured supplementary service data banking, payment and purchase transactions. The tracking and marketing system facilitates attribution of the one or more marketing campaigns for the plurality of banking partners.

### BRIEF DESCRIPTION OF THE FIGURES

Having thus described the invention in general terms, reference will now be made to the accompanying drawings, which are not necessarily drawn to scale, and wherein:

FIG. 1 illustrates an interactive computing environment for real-time tracking and attribution of advertisements for unstructured supplementary service data banking, in accordance with various embodiments of the present disclosure;

FIGS. 2A-2C illustrate a flowchart of a method for real-time tracking and attribution of advertisements for unstructured supplementary service data banking, in accordance with various embodiments of the present disclosure; and

FIG. 3 illustrates a block diagram of a computing device, in accordance with various embodiments of the present disclosure.

It should be noted that the accompanying figures are intended to present illustrations of exemplary embodiments of the present disclosure. These figures are not intended to limit the scope of the present disclosure. It should also be noted that accompanying figures are not necessarily drawn to scale.

### DETAILED DESCRIPTION

In the following description, for purposes of explanation, numerous specific details are set forth in order to provide a thorough understanding of the present technology. It will be apparent, however, to one skilled in the art that the present technology can be practiced without these specific details. In other instances, structures and devices are shown in block diagram form only in order to avoid obscuring the present technology.

Reference in this specification to “one embodiment” or “an embodiment” means that a particular feature, structure, or characteristic described in connection with the embodiment is included in at least one embodiment of the present technology. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Moreover, although the following description contains many specifics for the purposes of illustration, anyone skilled in the art will appreciate that many variations and/or alterations to said details are within the scope of the present technology. Similarly, although many of the features of the present technology are described in terms of each other, or in conjunction with each other, one skilled in the art will appreciate that many of these features can be provided independently of other features. Accordingly, this description of the present technology is set forth without any loss of generality to, and without imposing limitations upon, the present technology.

FIG. 1 illustrates a block diagram of an interactive computing environment 100 for real-time tracking and attribution of advertisements for unstructured supplementary service data banking, in accordance with various embodiments of the present disclosure. The unstructured supplementary service data banking includes USSD financial transactions or mobile transactions across verticals such as betting, investment, insurance, payments and transfers. The interactive computing environment 100 includes a plurality of subscribers 102, one or more communication devices 104, a communication network 106, a tracking and marketing system 108, a server 110 and an administrator 112. In addition, the interactive computing environment 100 includes one or more telecommunication network channels 114, a plurality of banking partners 116. Further, the tracking and marketing system 108 enables real-time tracking and attribution of advertisements for a plurality of subscriber transactions through the one or more telecommunication network channels 114. Furthermore, the plurality of subscriber transactions is associated with the plurality of banking partners 116. In an embodiment of the present disclosure, the tracking of the plurality of subscriber transactions from the plurality of subscribers 102 is securely performed on the one or more telecommunication network channels 114. In an embodiment of the present disclosure, one or more marketing campaigns are run through the one or more telecommunication network channels 114 on the one or more communication devices 104 in real-time.

The interactive computing environment 100 includes the plurality of subscribers 102. The plurality of subscribers 102 corresponds to any number of person or individual associated with the tracking and marketing system 108. The plurality of subscribers 102 performs the plurality of subscriber transactions with facilitation of the one or more communication devices 104. The one or more communication devices 104 provide an interface for the plurality of subscribers 102 to interact with the interactive computing environment 100. The plurality of subscribers 102 can interact with the interactive computing environment 100 through more than one device of the one or more communication devices 104. For example, a person Y at home connects with the interactive computing environment 100 through a basic feature phone to perform money transaction. The one or more communication devices 104 are associated with a specific type of operating system. The specific type of operating system includes a mac operating system, a windows operating system, an android operating system and the like. In an embodiment of the present disclosure, the operating system corresponds to any suitable operating system.

The interactive computing environment 100 includes the one or more telecommunication network channels 114. The one or more telecommunication network channels 114 correspond to any number of telecom organization associated with the tracking and marketing system 108 which provides voice or data transmission services. The one or more telecommunication network channels 114 perform media, voice and data transmission with facilitation of the communication network 106. The one or more telecommunication network channels 114 enable the plurality of subscribers 102 to perform the plurality of subscriber transactions for the plurality of banking partners 116. For example, a person X connects with the banking partner Y for the loan transaction using basic feature phone through the telecommunication network channel Z. In an embodiment of the present disclosure, the tracking and marketing system 108 receives a first set of data associated with the plurality of subscribers 102 from the one or more telecommunication network channels 114. In another embodiment of present disclosure, the tracking and marketing system 108 receives the first set of data associated with the plurality of subscribers 102 from the plurality of banking partners 116. In yet another embodiment of the present disclosure, the tracking and marketing system 108 receives the first set of data associated with the plurality of subscribers 102 from a third party database. The first set of data corresponds to a subscriber data. In an embodiment of the present disclosure, the subscriber data includes but may not be limited to name data, age data, gender, locations data, contact number data, and email address data, call behavior analytics, subscriber communication state. In another embodiment of the present disclosure, the subscriber data includes but may not be limited to communication device information, subscriber relationship status, subscriber active services, network address, and date of birth.

The interactive computing environment 100 includes the plurality of banking partners 116. The plurality of banking partners 116 corresponds to any number of banking industry associated with the tracking and marketing system 108 which provides financial transaction platform. In an embodiment of the present disclosure, the plurality of banking partners 116 performs the plurality of subscriber transactions based on unstructured supplementary service data with facilitation of the communication network 106. In an embodiment of the present disclosure, the tracking and marketing system 108 obtains a second set of data associated with the plurality of subscribers 102 from the plurality of banking partners 116. In another embodiment of the present disclosure, the tracking and marketing system 108 obtains the second set of data associated with the plurality of subscribers 102 from the third party database. The second set of data corresponds to a subscriber transaction data. In an embodiment of the present disclosure, the subscriber transaction data includes but may not be limited to the subscriber transaction data comprises banking partner name, and banking partner code. In another embodiment of the present disclosure, the subscriber transaction data includes but may not be limited to transaction amount, transaction identity, transaction date, transaction time, transaction requests, types of transaction, and item purchased.

The interactive computing environment 100 includes the one or more communication devices 104. The plurality of subscribers 102 is connected with the interactive computing environment 100 through the one or more communication devices 104. In an embodiment of the present disclosure, the tracking and marketing system 108 fetches a third set of data associated with activities of the plurality of subscribers 102 on the one or more communication devices 104 from a plurality of application servers. In another embodiment of the present disclosure, the tracking and marketing system 108 fetches the third set of data associated with the activities of the plurality of subscribers 102 on the one or more communication devices 104 from a third party database. The third set of data includes information of activities performed and interests of the plurality of subscribers 102 on one or more communication devices 104. In an embodiment of the present disclosure, the third set of data includes but may not be limited to subscriber surfing data, subscriber applications data, subscriber demographic data, subscriber finance activities, and subscriber banking data. In another embodiment of the present disclosure, the third set of data includes but may not be limited to subscriber clicks data, subscriber technology interests, subscriber language data, and application preference data. Furthermore, the plurality of application servers sends the third set of data in real-time to the tracking and marketing system 108.

Each of the one or more communication devices 104 includes one or more subscriber applications. In an embodiment of the present disclosure, the one or more communication devices 104 include any suitable application of the like. The function of the one or more communication devices 104 is to connect the plurality of subscribers 102 with the interactive computing environment 100. Each of the one or more communication devices 104 comprises of a memory. In general, memory includes computer-storage media in the form of volatile and/or nonvolatile memory. The memory may be removable, non-removable, or a combination thereof. Exemplary hardware devices include solid-state memory, hard drives, optical-disc drives, etc. The memory is coupled with one or more processors. In general, the one or more processor read data from various entities such as memory or I/O components. The one or more processor execute the one or more instructions which are stored in the memory. The one or more processors provide execution method for one or more instructions provided by the tracking and marketing system 108.

Each of the one or more communication devices 104 is a multimedia device. The one or more communication devices 104 enable the plurality of subscribers 102 to initiate the plurality of subscriber transactions through the plurality of banking partners 116. The one or more communication devices 104 support various transaction. The plurality of subscriber transactions includes but may not be limited to subscriber transactions for purchase, subscriber transactions for loan, subscriber transactions for mortgage, and subscriber transactions for banking. The plurality of subscribers 102 initiates the plurality of subscriber transactions for the plurality of banking partners 116 in real time through the one or more communication devices 104. In an embodiment of the present disclosure, each of the plurality of subscriber transactions is live banking transaction being initiated on the one or more communication devices 104. In an embodiment of the present disclosure, the plurality of subscriber transactions is transactions using unstructured supplementary service data. In general, unstructured supplementary service data transaction uses basic feature of the communication device. The internet facility is not compulsory for the unstructured supplementary service data banking. In another embodiment of the present disclosure, the plurality of subscriber transactions corresponds internet transaction on the plurality of application servers of the one or more communication devices 104. In yet another embodiment of the present disclosure, the plurality of subscriber transactions corresponds to transaction using a mobile wallet of the plurality of application servers on the one or more communication devices 104. The tracking and marketing system 108 receives information of the plurality of subscriber transactions from the plurality of banking partners 116 in real-time through the communication network 106.

The plurality of subscribers 102 accesses the one or more communication devices 104 in real time. Each of the one or more communication devices 104 includes a dedicated software platform to enable real time transaction of the plurality of subscriber transactions using unstructured supplementary service data. The dedicated software platform enables the one or more communication devices 104 to connect with the tracking and marketing system 108. In an embodiment of the present disclosure, the dedicated software platform is an application installed on the one or more communication devices 104. The one or more communication devices 104 include an application program based on the unstructured supplementary service data to connect with the plurality of banking partners 116 associated with the tracking and marketing system 108. In an embodiment of the present disclosure, the application program corresponds mobile texting. In another embodiment of the present disclosure, the application program corresponds prepaid roaming. In another embodiment of the present disclosure, the one or more communication devices 104 include a web based browser to connect with the tracking and marketing system 108. In another embodiment of the present disclosure, the one or more communication devices 104 include any other software platform to connect with the tracking and marketing system 108. In yet another embodiment of the present disclosure, the one or more communication devices 104 include banking transaction platforms. The one or more communication devices 104 serve as a platform of the interactive computing environment 100 for receiving information of the plurality of subscribers 102 in real time. The information of the plurality of subscribers 102 is accessible through the dedicated software platform.

The interactive computing environment 100 includes the tracking and marketing system 108. The tracking and marketing system 108 enables integration of the one or more telecommunication network channels 114, the plurality of banking partners 116, the plurality of application servers and the plurality of subscribers 102. The tracking and marketing system 108 performs tracking of the plurality of subscriber transactions in real-time. The tracking and marketing system 108 enables display of one or more advertisements associated with the one or more marketing campaigns. The tracking and marketing system 108 receives the first set of data from the one or more telecommunication network channels 114 and the plurality of banking partners 116 in real-time. The tracking and marketing system 108 obtains the second set of data associated to the plurality of subscribers 102 from the plurality of banking partners 116 in real-time. The tracking and marketing system 108 fetches the third set of data from the plurality of application servers based on the activities of the plurality of subscribers 102 in real-time through the one or more communication devices 104. The tracking and marketing system 108 enables identification of a match of the subscriber of the plurality of subscribers 102 and the corresponding plurality of subscriber transactions for initialization of the one or more marketing campaigns. The tracking and marketing system 108 enables creation of the one or more marketing campaigns for the identified subscriber associated with the corresponding plurality of subscriber transactions. The tracking and marketing system 108 triggers initialization of the one or more marketing campaigns on the one or more communication devices 104.

Furthermore, the interactive computing environment 100 enables the plurality of banking partners 116 to efficiently track the plurality of subscriber 102 executing the plurality of subscriber transactions. Moreover, the interactive computing environment 100 enables the one or more telecommunication network channels 114 to efficiently run the one or more marketing campaigns on the one or more communication devices 104 according to the interests of the plurality of subscribers 102. In addition, a subscriber of the plurality of subscriber 102 may be any person or individual currently accessing a communication device of the one or more communication devices 104. In an embodiment of the present disclosure, the communication device of the one or more communication devices 104 is a portable communication device. In another embodiment of the present disclosure, the communication device of the one or more communication devices 104 is not a portable communication device. The one or more communication devices 104 include but may not be limited to a smart phone, a desktop computer, a laptop, a tablet, a personal digital assistant, a wearable device and any other portable communication device known in the art. In addition, the one or more communication devices 104 are associated with a specific type of operating system. The specific type of operating system associated with the one or more communication devices 104 include but may not be limited to an Android operating system, iOS, Mac operating system, Windows operating system, Bada operating system and Symbian operating system.

In an embodiment of the present disclosure, the one or more communication devices 104 include an internet facility. In another embodiment of the present disclosure, the one or more communication devices 104 do not include the internet facility. In an embodiment of the present disclosure, the one or more communication devices 104 are presently connected to the internet. In another embodiment of the present disclosure, the one or more communication devices 104 are not connected to the internet. In an embodiment of the present disclosure, the one or more communication devices 104 are connected to the internet through a data connection provided by the one or more telecommunication network channels 114. In another embodiment of the present disclosure, the one or more communication devices 104 are connected to an internet broadband system, a local area network, a wide area network, a digital or analog cable television network or any other communication network presently known in the art. The internet broadband system maybe a wired or a wireless system.

In an embodiment of the present disclosure, the plurality of subscriber 102 uses the one or more communication devices 104 for accessing a telecommunication network channel of the one or more telecommunication network channels 114. The one or more communication devices 104 allow the plurality of subscribers 102 to access the plurality of application servers based on choice of the subscriber. In addition, the plurality of application servers displays one or more contents to the plurality of subscribers 102. Further, the one or more contents include but may not be limited to an audio content, audio-video content, a video content, and text content.

The one or more telecommunication network channels 114 correspond to one or more publishers for providing content to the subscriber of the plurality of subscribers 102. In another embodiment of the present disclosure, the one or more publishers include but may not be limited to an e-commerce website, a social networking website, a news website, a blog, and photo sharing website. In addition, the one or more telecommunication network channels 114 provide space, areas or a platform to the plurality of subscribers 102 for transmission of signs, signals, messages, words, writings, images and sounds or information for communicating purposes. Further, the one or more telecommunication network channels 114 are transmission modes to send multiple streams of information at a same time. Furthermore, the one or more telecommunication network channels 114 are facilitated through the tracking and marketing system 108. Moreover, the one or more telecommunication network channels 114 interconnect the plurality of subscribers 102 thought the communication network 106. Also, the subscriber of the plurality of subscribers 102 is a user associated with one of the telecommunication network channel of the one or more telecommunication network channels 114.

In addition, the one or more publishers display the one or more advertisements on the corresponding advertisement slots on the one or more communication devices 104. In an embodiment of the present disclosure, the one or more publishers correspond to the one or more telecommunication network channels 114. In another embodiment of the present disclosure, the one or more publishers correspond to the plurality of application servers. In an embodiment of the present disclosure, the one or more publishers 114 display the one or more advertisements when the subscriber interaction with the plurality of banking partners 116 for the plurality of subscriber transactions. In an embodiment of the present disclosure, the one or more advertisements are displayed for generating revenue based on number of impressions, number of banking services, number of telecom services, number of clicks and number of installs. In an embodiment of the present disclosure, the one or more advertisements are displayed after the exchange of information between the plurality of subscribers 102 with the plurality of banking partners 116. In an example, a subscriber X subscribes with a banking partner Y over a telephonic messaging through a telecommunication network channel Z after the telephonic messaging disconnects.

In an embodiment of the present disclosure, the one or more telecommunication network channels 114 send the first set of data associated with the subscriber of the plurality of subscribers 102 to the tracking and marketing system 108. In another embodiment of the present disclosure, the plurality of banking partners 116 sends the first set of data associated with the subscriber of the plurality of subscribers 102 to the tracking and marketing system 108. In addition, the first set of data corresponds to the subscriber data In an embodiment of the present disclosure, the first set of data enables the tracking and marketing system 108 to collect information associated with the subscriber of the plurality of subscribers 102 and the corresponding one or more communication devices 104. In an embodiment of the present disclosure, the first set of data includes but may not be limited to name data, age data, gender, locations data, contact number data, email address data, communication device information, and call behavior analytics. In another embodiment of the present disclosure, the first set of data includes but may not be limited to subscriber communication state, subscriber relationship status, subscriber active services, network address, and date of birth. The one or more telecommunication network channels 114 send the first set of data in real-time.

In addition, the plurality of banking partners 116 transfers the second set of data associated with the plurality of subscribers 102 to the tracking and marketing system 108 through the communication network 106. Further, the second set of data corresponds to the subscriber transaction data. In an embodiment of the present disclosure, the second set of data enables the tracking and marketing system 108 to recognize and identify the transaction of the subscriber of the plurality of subscribers 102. The second set of data includes but may not be limited to banking partner name, banking partner code, transaction amount, transaction identity, transaction date, transaction time, transaction requests, types of transaction, and item purchased. Further, the plurality of banking partners 116 transfers the second set of data in real-time to the tracking and marketing system 108.

In addition, the plurality of application servers sends the third set of data associated with the plurality of subscribers 102 to the tracking and marketing system 108 through the communication network 106. Further, the third set of data corresponds to activities and interests of the subscriber of the plurality of subscribers 102 based on the corresponding one or more communication devices 104. In an embodiment of the present disclosure, the third set of data enables the tracking and marketing system 108 to identify the activities of the subscriber of the plurality of subscribers 102. The third set of data includes but may not be limited to subscriber surfing data, subscriber applications data, subscriber demographic data, subscriber technology interests, subscriber language data, application preference data, and subscriber clicks data. Furthermore, the plurality of application servers sends the third set of data in real-time to the tracking and marketing system 108.

In addition, the tracking and marketing system 108 analyzes the first set of data, the second set of data, and the third set of data based on one or more machine learning algorithms. In an embodiment of the present disclosure, the one or more machine learning algorithms include a decision tree algorithm and a random forest algorithm. In another embodiment of the present disclosure, the one or more machine learning algorithms include but may not be limited to prediction algorithms, deep learning algorithms, natural language processing algorithm and the like. However, the one or more machine learning algorithms are not limited to the above-mentioned algorithms. The analysis of the first set of data, the second set of data, and the third set of data based on the one or more machine learning algorithms is done in real-time.

In addition, the tracking and marketing system 108 creates a machine learning model to perform identification of the subscriber of the plurality of subscribers 102 and tracking the corresponding plurality of subscriber transactions. The machine learning model is trained based on analyzed first set of data, second set of data and third set of data based on one or more patterns of the first set of data, the second set of data, and the third set of data. Further, the machine learning model is trained to analyze the first set of data, the second set of data, and the third set of data. Furthermore, the machine learning model is trained to identify the match of the subscriber of the plurality of subscribers 102 and the corresponding plurality of subscriber transactions. In an embodiment of the present disclosure, the machine learning model is trained using supervised machine learning model. In another embodiment of the present disclosure, the machine learning model is trained using un-supervised machine learning model.

In addition, the tracking and marketing system 108 creates a plurality of subscriber profiles associated with the plurality of subscribers 102. Further, each of the plurality of subscriber profiles of corresponding plurality of subscribers 102 is created based on analyzed first set of data, second set of data, and third set of data through the machine learning model. The tracking and marketing system 108 creates the plurality of subscriber profiles in real-time. Furthermore, the tracking and marketing system 108 sends the plurality of subscriber profiles to the one or more telecommunication network channels 114 and the plurality of banking partners 116. Moreover, the tracking and marketing system 108 sends the plurality of subscriber profiles to the one or more telecommunication network channels 114 and the plurality of banking partners 116 through the communication network 106.

In addition, the tracking and marketing system 108 generates a plurality of groups associated with the plurality of subscribers 102. Further, each of the plurality of groups of the corresponding plurality of subscribers 102 is generated based on the plurality of subscriber profiles using the plurality of subscriber transactions through the machine learning model. The tracking and marketing system 108 generates the plurality of groups in real-time. The plurality of subscriber transactions includes but may not be limited to subscriber transactions for purchase, subscriber transactions for loan, subscriber transactions for mortgage, and subscriber transactions for banking. In an embodiment of the present disclosure, a subscriber transaction of the plurality of subscriber transactions is a transaction using unstructured supplementary service data. In general, unstructured supplementary service data transaction uses basic feature of the communication device. The internet facility is not compulsory for the unstructured supplementary service data banking. Furthermore, the tracking and marketing system 108 sends the plurality of groups to the one or more telecommunication network channels 114 and the plurality of banking partners 116 through the communication network 106.

In addition, the one or more telecommunication network channels 114 and the plurality of banking partners 116 are associated through one or more advertisement supplying intermediaries. Further, the advertisement supplying intermediaries enables a connection or link between the one or more telecommunication network channels 114 and the plurality of banking partners 116. In an embodiment of the present disclosure, the advertisement supplying intermediaries works as a third party medium for efficient buying and selling of the one or more advertisement slots. In an embodiment of the present disclosure, the advertisement supplying intermediaries is a platform for buying and selling of advertisement inventory between the one or more telecommunication network channels 114 and the plurality of banking partners 116. In an embodiment of the present disclosure, the advertisement supplying intermediaries deal with the one or more telecommunication network channels 114 and the plurality of banking partners 116 through a mutual contract for defining terms and conditions associated with revenue.

In addition, the one or more communication devices 104 are associated with the communication network 106. In an embodiment of the present disclosure, the one or more communication devices 104 are integrated with the one or more telecommunication network channels 114, and the plurality of banking partners 116 through the communication network 106. In an embodiment of the present disclosure, the advertisement supplying intermediaries is associated with the one or more telecommunication network channels 114 and the plurality of banking partners 116 through the communication network 106.

In addition, the communication network 106 enables the one or more communication devices 104 to connect to the internet. In an embodiment of the present disclosure, the subscriber accesses the plurality of banking partners 116 and the one or more telecommunication network channels 114 on the corresponding one or more communication devices through the communication network 106. Further, the medium for communication may be infrared, microwave, radio frequency (RF) and the like. The communication network 106 includes but may not be limited to a local area network, a metropolitan area network, a wide area network, a virtual private network, a global area network and a home area network. The communication network 106 is a structure of various nodes or communication devices connected to each other through a network topology method. The network topology includes a bus topology, a star topology, a mesh topology and the like.

In addition, the one or more telecommunication network channels 114, the plurality of banking partners 116, and the plurality of application servers are associated with the tracking and marketing system 108. In an embodiment of the present disclosure, the one or more telecommunication network channels 114, the plurality of banking partners 116, and the plurality of application servers are associated with the tracking and marketing system 108. Moreover, the tracking and marketing system 108 performs the tracking of each of the plurality of subscribers 102 connected on the one or more telecommunication network channels 114 while executing the plurality of subscriber transactions.

In addition, the tracking and marketing system 108 receives a set of rules. The set of rules is received from a server 110 based on one or more inputs of the administrator 112. The one or more inputs include but may not be limited to optimal time for marketing campaign, optimal marketing model, optimal banking balance, optimal season for marketing, and optimal tariff mark. Further, the set of rules can be modified by the administrator 112 in real-time. Furthermore, the tracking and marketing system 108 customizes the one or more marketing campaigns for the tracked and identified subscriber of the plurality of subscribers 102 associated with the corresponding plurality of subscriber transactions. The customization of the one or more marketing campaigns are based on the one or more inputs by the administrator 112, wherein the one or more marketing campaigns are customized in real-time.

In addition, the tracking and marketing system 108 identifies each of the plurality of subscribers 102 based on analysis of corresponding plurality of subscriber profiles for initiating the one or more marketing campaigns. Further, the one or more marketing campaigns include advertisement goals related to the plurality of banking partners 116 and the one or more telecommunication network channels 114. The advertisement goals are targets wished to achieve by the plurality of banking partners 116. Each of the plurality of subscribers 102 is identified for the one or more marketing campaigns in real-time. In an embodiment of the present disclosure, the each of the plurality of subscribers 102 is identified based on the analysis done by the machine learning model and the created plurality of subscriber profiles in the plurality of groups.

In addition, the tracking and marketing system 108 alerts the one or more telecommunication network channels 114, the plurality of banking partners 116 and the administrator 112 based on tracked and identified subscriber of the plurality of subscribers 102. The tracking and marketing system 108 triggers initialization of the one more marketing campaigns on the one or more communication devices 104 based on a pre-defined criterion. The pre-defined criterion includes but may not be limited to end of transaction session, end of online banking session, end of offline banking session, end of short message service, end of voice call, and end of short message service data. In an embodiment of the present disclosure, the pre-defined criterion is defined by the administrator 112. In another embodiment of the present disclosure, the pre-defined criterion is defined by the plurality of banking partners 116. In yet another embodiment of the present disclosure, the pre-defined criterion is defined by the one or more telecommunication network channels 114.

In addition, the tracking and marketing system 108 displays the one or more advertisements associated with the one or more marketing campaigns based on tracked and identified plurality of subscribers 102. In an embodiment of the present disclosure, the tracking and marketing system 108 provides the acquisition based one or more marketing campaigns to the plurality of banking partners 116. In an embodiment of the present disclosure, the one or more advertisements are displayed on the one or more communication devices 104 in the form of flash messages. In another embodiment of the present disclosure, the one or more advertisements are displayed on the one or more communication devices 104 in the form of text messages. In yet another embodiment of the present disclosure, the one or more advertisements are displayed on the one or more communication devices 104 in the form of telephonic calls. In yet another embodiment of the present disclosure, the one or more advertisements are displayed on the one or more communication devices 104 in the form of multimedia messages. The one or more advertisements are displayed on the one or more communication devices 104 in real-time. The one or more advertisements are displayed on the one or more communication devices 104 in the form of flash messages based on the analysis of the first set of data, the second set of data and the third set of data. In an embodiment of the present disclosure, the one or more advertisements displayed are associated with the interests of the subscriber of the plurality of subscribers 102. In an embodiment of the present disclosure, the one or more advertisements correspond to a content viewing history and activities of the plurality of subscribers 102 on the plurality of subscriber transactions for attracting more number of clicks.

The interactive computing environment 100 further includes the server 110 and the database 110a. The tracking and marketing system 108 is associated with the server 110. In general, the server 110 is a computer program or device that provides functionality for other programs or devices. The server 110 provides various functionalities, such as sharing data or resources among multiple clients, or performing computation for a client. However, those skilled in the art would appreciate that the tracking and marketing system 108 is connected to more number of servers 110. Furthermore, it may be noted that the server 110 includes the database 110a. However, those skilled in the art would appreciate that more number of the servers 110 include more numbers of database 110a.

In an embodiment of the present disclosure, the tracking and marketing system 108 is located in the server 110. In another embodiment of the present disclosure, the tracking and marketing system 108 is connected with the server 110. In yet another embodiment of the present disclosure, the tracking and marketing system 108 is a part of the server 110. The server 110 handles each operation and task performed by the tracking and marketing system 108. The server 110 stores one or more instructions for performing the various operations of the tracking and marketing system 108. The server 110 is located remotely from the one or more sellers. The server 110 is associated with the administrator 112. In general, the administrator 112 manages the different components in the tracking and marketing system 108. The administrator 112 coordinates the activities of the components involved in the tracking and marketing system 108. The administrator 112 is any person or individual who monitors the working of the tracking and marketing system 108 and the server 110 in real time. The administrator 112 monitors the working of the tracking and marketing system 108 and the server 110 through a communication device. The communication device includes the laptop, the desktop computer, the tablet, a personal digital assistant and the like.

The database 110a store different sets of information associated with various components of the tracking and marketing system 108. In general, the database 110a are used to hold general information and specialized data, such as characteristics data of the plurality of subscribers 102, data of the one or more communication devices 104, data of the one or more telecommunication network channels 114 and the like. For examples, the database 110a includes characteristic data of the plurality of subscribers 102 and the pre-defined instructions. The database 110a stores the information of the plurality of banking partners 116, the one or more communication devices 104, the profiles of the plurality of subscribers 102, demographic information of the plurality of subscribers 102 and the like. The database 110a organize the data using model such as relational models or hierarchical models. Further, the database 110a store data provided by the plurality of banking partners 116.

FIGS. 2A-2C illustrate a flow chart 200 of the method for real-time tracking and attribution of advertisements for unstructured supplementary service data banking, in accordance with various embodiments of the present disclosure. It may be noted that in order to explain the method steps of the flowchart 200, references will be made to the elements explained in FIG. 1. The flow chart 200 starts at step 202. at step 204, the tracking and marketing system 108 enables integration of the one or more telecommunication network channels 114, the plurality of banking partners 116, the plurality of application servers and the plurality of subscribers 102. At step 206, the tracking and marketing system 108 receives the first set of data associated with the plurality of subscribers 102. At step 208, the tracking and marketing system 108 obtains the second set of data associated with the plurality of subscribers 102. At step 210, the tracking and marketing system 108 fetches the third set of data associated with the plurality of subscribers 102. At step 212, the tracking and marketing system 108 analyzes the first set of data, the second set of data, and the third set of data based on the one or more machine learning algorithms. At step 214, the tracking and marketing system 108 identifies the match of the subscriber of the plurality of subscribers 102 and the corresponding plurality of subscriber transactions. At step 216, the tracking and marketing system 108 enables tracking of the subscriber of the plurality of subscribers 102 associated with the corresponding one or more communication devices 104. At step 218, the tracking and marketing system 108 creates the one or more marketing campaigns for the identified subscriber of the plurality of subscribers 102. At 220, the tracking and marketing system 108 triggers initialization of the one or more marketing campaigns on the one or more communication devices 104. At 222, the tracking and marketing system 108 displays the one or more advertisements associated with the one or more marketing campaigns.

The flow chart 200 terminates at step 224. It may be noted that the flowchart 200 is explained to have above stated process steps; however, those skilled in the art would appreciate that the flowchart 200 may have more/less number of process steps which may enable all the above stated embodiments of the present disclosure.

FIG. 3 illustrates the block diagram of a computing device 300, in accordance with various embodiments of the present disclosure. The computing device 300 includes a bus 302 that directly or indirectly couples the following devices: memory 304, one or more processors 206, one or more presentation components 308, one or more input/output (I/O) ports 310, one or more input/output components 312, and an illustrative power supply 314. The bus 302 represents what may be one or more busses (such as an address bus, data bus, or combination thereof). Although the various blocks of FIG. 3 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 3 is merely illustrative of an exemplary computing device 300 that can be used in connection with one or more embodiments of the present invention. Distinction is not made between such categories as “workstation,” “server,” “laptop,” “hand-held device,” etc., as all are contemplated within the scope of FIG. 3 and reference to “computing device.”

The computing device 300 typically includes a variety of computer-readable media. The computer-readable media can be any available media that can be accessed by the computing device 300 and includes both volatile and nonvolatile media, removable and non-removable media. By way of example, and not limitation, the computer-readable media may comprise computer storage media and communication media. The computer storage media includes volatile and nonvolatile, removable and non-removable media implemented in any method or technology for storage of information such as computer-readable instructions, data structures, program modules or other data.

The computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 300. The communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 304 includes computer-storage media in the form of volatile and/or nonvolatile memory. The memory 304 may be removable, non-removable, or a combination thereof. Exemplary hardware devices include solid-state memory, hard drives, optical-disc drives, etc. The computing device 300 includes one or more processors that read data from various entities such as memory 304 or I/O components 312. The one or more presentation components 308 present data indications to a subscriber or other device. Exemplary presentation components include a display device, speaker, printing component, vibrating component, etc. The one or more I/O ports 310 allow the computing device 300 to be logically coupled to other devices including the one or more I/O components 312, some of which may be built in. Illustrative components include a microphone, joystick, game pad, satellite dish, scanner, printer, wireless device, etc.

The present disclosure has several advantages over the prior art. The present disclosure provides the platform for tracking the plurality of subscriber transactions made by the plurality of subscribers through the one or more telecommunication network channels. The present disclosure provides the system for analysis of the subscriber data, the subscriber transaction data and the subscriber activities data. The present disclosure provides identification of the subscriber based on the plurality of subscriber profiles on the one or more telecommunication network channels for displaying relevant one or more advertisement in real-time. The present disclosure provides advertisement for the specific identified and tracked subscriber of the plurality of subscribers according to the subscriber interest in real-time.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

While several possible embodiments of the invention have been described above and illustrated in some cases, it should be interpreted and understood as to have been presented only by way of illustration and example, but not by limitation. Thus, the breadth and scope of a preferred embodiment should not be limited by any of the above-described exemplary embodiments.

What is claimed is:

1. A computer-implemented method for real-time tracking and attribution of advertisements for unstructured supplementary service data banking, the unstructured supplementary service data banking comprises USSD financial transactions or mobile transactions across multiple verticals, the computer-implemented method comprising:
enabling, at a tracking and marketing system with a processor, integration of one or more telecommunication network channels, a plurality of banking partners and a plurality of application servers, wherein the one or more telecommunication network channels, the plurality of banking partners and the plurality of application servers are integrated in real-time through a communication network;
receiving, at the tracking and marketing system with the processor, a first set of data associated with the plurality of subscribers, wherein the plurality of subscribers is associated with one or more communication devices, wherein the first set of data is received with facilitation of the one or more telecommunication network channels and the plurality of banking partners in real-time;
obtaining, at the tracking and marketing system with the processor, a second set of data associated with the plurality of subscribers, wherein the second set of data is received with facilitation of the plurality of banking partners in real-time;
fetching, at the tracking and marketing system with the processor, a third set of data associated with the plurality of subscribers, wherein the third set of data is fetched from the plurality of application servers based on activities of the plurality of subscribers in real-time through the one or more communication devices;
analyzing, at the tracking and marketing system with the processor, the first set of data, the second set of data, and the third set of data based on one or more machine learning algorithms, wherein the analysis is performed based on training of a machine learning model, wherein analysis is performed based on one or more patterns to identify and track a subscriber of the plurality of subscribers and corresponding plurality of subscriber transactions, wherein the analysis of the first set of data, the second set of data, and the third set of data is done in real-time;
identifying, at the tracking and marketing system with the processor, a match of the subscriber of the plurality of subscribers and the corresponding plurality of subscriber transactions for initialization of one or more marketing campaigns, wherein the match of the subscriber and the corresponding plurality of subscriber transactions is identified in real-time;
enabling, at the tracking and marketing system with the processor, tracking of the subscriber of the plurality of subscribers associated with corresponding communication devices of the one or more communication devices based on the corresponding plurality of subscriber transactions, wherein the subscriber is tracked based on the corresponding plurality of subscriber transactions in real-time;
creating, at the tracking and marketing system with the processor, the one or more marketing campaigns for the identified subscriber of the plurality of subscribers associated with the corresponding plurality of subscriber transactions based on the analyzed first set of data, the second set of data, and third set of data, wherein the one or more marketing campaigns are created in real-time;
triggering, at the tracking and marketing system with the processor, initialization of the one or more marketing campaigns on the one or more communication devices based on a pre-defined criterion, wherein the pre-defined criterion is associated with the plurality of banking partners and the one or more telecommunication network channels based on the identified subscriber of the plurality of subscribers, wherein the one or more marketing campaigns are triggered in the real-time; and
displaying, at the tracking and marketing system with the processor, one or more advertisements associated with the one or more marketing campaigns based on identified subscriber of the plurality of subscribers, wherein the one or more advertisements are displayed on the one or more communication devices, wherein the one or more advertisements are displayed on the one or more communication devices in real-time,
wherein the tracking and marketing system provides tracking attribution for the unstructured supplementary service data banking, wherein the tracking and marketing system facilitates attribution of the one or more marketing campaigns for the plurality of banking partners.

2. The computer-implemented method as recited in claim 1, wherein the advertising system with the processor connects with the one or more telecommunication network channels through the communication network, wherein the first set of data corresponds to a subscriber data, wherein the subscriber data is received through the one or more telecommunication network channels, wherein the subscriber data comprises name data, age data, gender, locations data, contact number data, email address data, communication device information, call behavior analytics, subscriber communication state, subscriber relationship status, subscriber active services, network address, and date of birth.

3. The computer-implemented method as recited in claim 1, wherein the second set of data corresponds to a subscriber transaction data, wherein the subscriber transaction data comprises banking partner name, banking partner code, transaction amount, transaction identity, transaction date, transaction time, transaction requests, types of transaction, and item purchased, wherein the communication network provides a medium for the plurality of subscribers to connect with the tracking and marketing system through the one or more communication devices.

4. The computer-implemented method as recited in claim 1, wherein the third set of data corresponds to the activities of the plurality of subscribers based on the plurality of applications servers through the one or more communication devices, wherein the third set of data comprises subscriber surfing data, subscriber applications data, subscriber demographic data, subscriber technology interests, subscriber language data, application preference data, and subscriber clicks data.

5. The computer-implemented method as recited in claim 1, further comprising creating, at the tracking and marketing system with the processor, the machine learning model to perform analysis of the first set of data, the second set of data, and the third set of data, wherein the machine learning model is trained based on the one or more patterns to identify and track the subscriber of the plurality of subscribers from the analyzed first set of data, second set of data, and third set of data.

6. The computer-implemented method as recited in claim 1, further comprising generating, at the tracking and marketing system with the processor, a plurality of groups associated with the plurality of subscribers based on analyzed first set of data, second set of data, and third set of data using the plurality of subscriber transactions, wherein the plurality of subscriber transactions comprises subscriber transactions for purchase, subscriber transactions for loan, subscriber transactions for mortgage, and subscriber transactions for banking, wherein the plurality of groups is guided to the plurality of banking partners and the one or more telecommunication network channels through the communication network, wherein each of the plurality of groups is generated and sent in real-time.

7. The computer-implemented method as recited in claim 1, further comprising receiving, at the tracking and marketing system with the processor, a set of rules, wherein the set of rules is received from a server based on one or more inputs of an administrator, wherein the one or more inputs comprises optimal time for marketing campaign, optimal marketing model, optimal banking balance, optimal season for marketing, and optimal tariff mark, wherein the set of rules can be modified by the administrator in real-time.

8. The computer-implemented method as recited in claim 1, further comprising customizing, at the tracking and marketing system with the processor, the one or more marketing campaigns for the identified subscriber of the plurality of subscribers associated with the corresponding plurality of subscriber transactions based on the one or more inputs by the administrator, wherein the one or more marketing campaigns are customized in real-time.

9. The computer-implemented method as recited in claim 1, each of the plurality of subscriber is identified and tracked based on analysis done by the machine learning model for initiating the one or more marketing campaigns, wherein the one or more marketing campaigns comprise advertisement goals of the plurality of banking partners and the one or more telecommunication network channels, wherein the advertisement goals are targets wished to achieve by the plurality of banking partners and the one or more telecommunication network channels, wherein each of the plurality of subscriber is identified and tracked for the one or more marketing campaigns in real-time.

10. The computer-implemented method as recited in claim 1, the identified and tracked subscriber of the plurality of subscribers associated with the corresponding one or more communication devices receives the one or more advertisements based on the one or more marketing campaigns, wherein the one or more advertisements are displayed on the plurality of communication devices based on the analysis of the first set of data, the second set of data, and the third set of data, wherein the plurality of banking partners, the one or more telecommunication network channels and the administrator are alerted based on the pre-defined criterion for initiation of the one or more marketing campaigns, wherein the pre-defined criterion comprises end of transaction session, end of online banking session, end of offline banking session, end of short message service, end of voice call, and end of short message service data.

11. A computer system comprising:
one or more processors; and
a memory coupled to the one or more processors, the memory for storing instructions which, when executed by the one or more processors, cause the one or more processors to perform a method for real-time tracking and attribution of advertisements for unstructured supplementary service data banking, the unstructured supplementary service data banking comprises USSD financial transactions or mobile transactions across multiple verticals, the method comprising:
enabling, at a tracking and marketing system, integration of one or more telecommunication network channels, a plurality of banking partners and a plurality of application servers, wherein the one or more telecommunication network channels, the plurality of banking partners and the plurality of application servers are integrated in real-time through a communication network;
receiving, at the tracking and marketing system, a first set of data associated with the plurality of subscribers, wherein the plurality of subscribers is associated with one or more communication devices, wherein the first set of data is received with facilitation of the one or more telecommunication network channels and the plurality of banking partners in real-time;
obtaining, at the tracking and marketing system, a second set of data associated with the plurality of subscribers, wherein the plurality of subscribers is associated with the one or more of communication devices, wherein the second set of data is received with facilitation of the plurality of banking partners in real-time;
fetching, at the tracking and marketing system, a third set of data associated with the plurality of subscribers, wherein the third set of data is fetched from the plurality of application servers based on activities of the plurality of subscribers in real-time through the one or more communication devices;
analyzing, at the tracking and marketing system, the first set of data, the second set of data, and the third set of data based on one or more machine learning algorithms, wherein the analysis is performed based on training of a machine learning model, wherein analysis is performed based on one or more patterns to identify and track a subscriber of the plurality of subscriber and corresponding plurality of subscriber transactions, wherein the analysis of the first set of data, the second set of data, and the third set of data is done in real-time;
identifying, at the tracking and marketing system, a match of the subscriber of the plurality of subscribers and the corresponding plurality of subscriber transactions for initialization of one or more marketing campaigns, wherein the match of the subscriber and the corresponding plurality of subscriber transactions is identified in real-time;
enabling, at the tracking and marketing system, tracking of the subscriber of the plurality of subscribers associated with corresponding communication devices of the one or more communication devices based on the corresponding plurality of subscriber transactions, wherein the subscriber is tracked based on the corresponding plurality of subscriber transactions in real-time;
creating, at the tracking and marketing system, the one or more marketing campaigns for the identified subscriber of the plurality of subscribers associated with the corresponding plurality of subscriber transactions based on the analyzed first set of data, second set of data, and third set of data, wherein the one or more marketing campaigns are created in real-time;
triggering, at the tracking and marketing system, initialization of the one or more marketing campaigns on the one or more communication devices based on a pre-defined criterion, wherein the pre-defined criterion is associated with the plurality of banking partners and the one or more telecommunication network channels based on the identified subscriber of the plurality of subscribers, wherein the one or more marketing campaigns are triggered in the real-time; and
displaying, at the tracking and marketing system, one or more advertisements associated with the one or more marketing campaigns based on identified subscriber of the plurality of subscribers, wherein the one or more advertisements are displayed on the one or more communication devices, wherein the one or more advertisements are displayed on the one or more communication devices in real-time,
wherein the tracking and marketing system provides tracking attribute for unstructured supplementary service data banking, payment and purchase transactions, wherein the tracking and marketing system facilitates attribution of the one or more marketing campaigns for the plurality of banking partners.

12. The computer system as recited in claim 11, wherein the advertising system connects with the one or more telecommunication network channels through the communication network, wherein the first set of data corresponds to a subscriber data, wherein the subscriber data is received through the one or more telecommunication network channels, wherein the subscriber data comprises name data, age data, gender, locations data, contact number data, email address data, communication device information, call behavior analytics, subscriber communication state, subscriber relationship status, subscriber active services, network address, and date of birth.

13. The computer system as recited in claim 11, wherein the second set of data corresponds to a subscriber transaction data, wherein the subscriber transaction data comprises banking partner name, banking partner code, transaction amount, transaction identity, transaction date, transaction time, transaction requests, types of transaction, and item purchased, wherein the communication network provides a medium for the plurality of subscribers to connect with the tracking and marketing system through the one or more communication devices.

14. The computer system as recited in claim 11, wherein the third set of data corresponds to the activities of the plurality of subscribers based on the plurality of applications servers through the one or more communication devices, wherein the third set of data comprises subscriber surfing data, subscriber applications data, subscriber demographic data, subscriber technology interests, subscriber language data, application preference data, and subscriber clicks data.

15. The computer system as recited in claim 11, further comprising creating, at the tracking and marketing system, the machine learning model to perform analysis of the first set of data, the second set of data, and the third set of data, wherein the machine learning model is trained based on the one or more patterns to identify and track the subscriber of the plurality of subscribers from the analyzed first set of data, second set of data, and third set of data.

16. The computer system as recited in claim 11, further comprising generating, at the tracking and marketing system, a plurality of groups is associated with the plurality of subscribers based on analyzed first set of data, second set of data, and third set of data using the plurality of subscriber transactions, wherein the plurality of subscriber transactions comprises subscriber transactions for purchase, subscriber transactions for loan, subscriber transactions for mortgage, and subscriber transactions for banking, wherein the plurality of groups is guided to the plurality of banking partners and the one or more telecommunication network channels through the communication network, wherein each of the plurality of groups is generated and sent in real-time.

17. The computer system as recited in claim 11, further comprising receiving, at the tracking and marketing system, a set of rules, wherein the set of rules is received from a server based on one or more inputs of an administrator, wherein the one or more inputs comprises optimal time for marketing campaign, optimal marketing model, optimal banking balance, optimal season for marketing, and optimal tariff mark, wherein the set of rules can be modified by the administrator in real-time.

18. The computer system as recited in claim 11, each of the plurality of subscriber is identified and tracked based on analysis done by the machine learning model for initiating the one or more marketing campaigns, wherein the one or more marketing campaigns comprise advertisement goals of the plurality of banking partners and the one or more telecommunication network channels, wherein the advertisement goals are targets wished to achieve by the plurality of banking partners and the one or more telecommunication network channels, wherein each of the plurality of subscriber is identified and tracked for the one or more marketing campaigns in real-time.

19. The computer system as recited in claim 11, the identified and tracked subscriber of the plurality of subscribers associated with the corresponding one or more communication devices receives the one or more advertisements based on the one or more marketing campaigns, wherein the one or more advertisements are displayed on the plurality of communication devices based on the analysis of the first set of data, the second set of data, and the third set of data, wherein the plurality of banking partners, the one or more telecommunication network channels and the administrator are alerted based on the pre-defined criterion for initiation of the one or more marketing campaigns, wherein the pre-defined criterion comprises end of transaction session, end of online banking session, end of offline banking session, end of short message service, end of voice call, and end of short message service data.

20. A non-transitory computer-readable storage medium encoding computer executable instructions that, when executed by at least one processor, performs a method for real-time tracking and attribution of advertisements for unstructured supplementary service data banking, the unstructured supplementary service data banking comprises USSD financial transactions or mobile transactions across multiple verticals, the method comprising:
enabling, at a computing device, integration of one or more telecommunication network channels, a plurality of banking partners and a plurality of application servers, wherein the one or more telecommunication network channels, the plurality of banking partners and the plurality of application servers are integrated in real-time through a communication network;
receiving, at the computing device, a first set of data associated with the plurality of subscribers, wherein the plurality of subscribers is associated with one or more communication devices, wherein the first set of data is received with facilitation of the one or more telecommunication network channels and the plurality of banking partners in real-time;
obtaining, at the computing device, a second set of data associated with the plurality of subscribers, wherein the plurality of subscribers is associated with the one or more of communication devices, wherein the second set of data is received with facilitation of the plurality of banking partners in real-time;
fetching, at the computing device, a third set of data associated with the plurality of subscribers, wherein the third set of data is fetched from the plurality of application servers based on activities of the plurality of subscribers in real-time through the one or more communication devices;
analyzing, at the computing device, the first set of data, the second set of data, and the third set of data based on one or more machine learning algorithms, wherein the analysis is performed based on training of a machine learning model, wherein analysis is performed based on one or more patterns to identify and track a subscriber of the plurality of subscriber and corresponding plurality of subscriber transactions, wherein the analysis of the first set of data, the second set of data, and the third set of data is done in real-time;
identifying, at the computing device, a match of the subscriber of the plurality of subscribers and the corresponding plurality of subscriber transactions for initialization of one or more marketing campaigns, wherein the match of the subscriber and the corresponding plurality of subscriber transactions is identified in real-time;
enabling, at the computing device, tracking of the subscriber of the plurality of subscribers associated with corresponding communication devices of the one or more communication devices based on the corresponding plurality of subscriber transactions, wherein the subscriber is tracked based on the corresponding plurality of subscriber transactions in real-time;
creating, at the computing device, the one or more marketing campaigns for the identified subscriber of the plurality of subscribers associated with the corresponding plurality of subscriber transactions based on the analyzed first set of data, second set of data, and third set of data, wherein the one or more marketing campaigns are created in real-time;
triggering, at the computing device, initialization of the one or more marketing campaigns on the one or more communication devices based on a pre-defined criterion, wherein the pre-defined criterion is associated with the plurality of banking partners and the one or more telecommunication network channels based on the identified subscriber of the plurality of subscribers, wherein the one or more marketing campaigns are triggered in the real-time; and
displaying, at the computing device, one or more advertisements associated with the one or more marketing campaigns based on identified subscriber of the plurality of subscribers, wherein the one or more advertisements are displayed on the one or more communication devices, wherein the one or more advertisements are displayed on the one or more communication devices in real-time,
wherein the computing device provides tracking attribute for unstructured supplementary service data banking, payment and purchase transactions, wherein the computing device facilitates attribution of the one or more marketing campaigns for the plurality of banking partners.
